(19) United States
(12) Patent Application Publication
(10) Pub. No.: US 2025/0307162 A1
(43) Pub. Date: Oct. 2, 2025

(54) Cache Data Distribution for a Stacked Die Configuration

(71) Applicant: Advanced Micro Devices, Inc., Santa Clara, CA (US)

(72) Inventors: Matthew Donald Schoenwald, Fort Collins, CO (US); Paul James Moyer, Fort Collins, CO (US); William Louie Walker, Fort Collins, CO (US)

(73) Assignee: Advanced Micro Devices, Inc., Santa Clara, CA (US)

(21) Appl. No.: 18/621,610

(22) Filed: Mar. 29, 2024

(51) Int. Cl. G06F 12/0864

(52) U.S. Cl. CPC G06F 12/0864; G06F 2212/6032

(57) ABSTRACT

An example system may include a first physical memory integrated within a first die, and a second physical memory integrated within a second die. The first die and second die are coupled in a stack arrangement. The system may also include a cache controller configured to implement a plurality of cache ways of a set associative cache. The plurality of cache ways include a first cache way defined within the first physical memory and a second cache way defined within the second physical memory.

### BACKGROUND

A semiconductor wafer is a slice of semiconductor material, such as silicon, on which multiple identical integrated circuits or chips are fabricated simultaneously. The semiconductor wafer is diced into individual semiconductor components, referred to as dies. In some examples, a die includes one or more execution units, control units, registers, cache memories, and other functional units that enable execution of instructions. Further, a die includes one or more physical communication channels, or interconnects, that facilitate communication between different components of the die.

### BRIEF DESCRIPTION OF THE DRAWINGS

FIG. 1 is a block diagram of a non-limiting example system having one or more dies operable to implement cache data distribution for a stacked die configuration.

FIG. 2 is a non-limiting example top view and side view of a stacked die configuration.

FIG. 3 depicts a non-limiting example system operable to implement a set associative cache.

FIG. 4 depicts a procedure in an example implementation of cache data distribution for a stacked die configuration.

### DETAILED DESCRIPTION

### Overview

Processing devices, such as a central processing unit (CPU), a graphics processing unit (GPU), an accelerator unit, a system on chip (SoC), and the like, are often implemented on semiconductor dies. Such systems are conventionally integrated on a single planar die having a processor core that is partially surrounded by various other elements, such as cache extensions, used to support functionality of the core. Conventionally, since different computing applications have different requirements, the available cache memory of a system is scaled by re-designing the semiconductor device to include additional cache extensions. For example, when an additional cache memory is added, a cache controller and other circuitry (e.g., wiring, data fabric, etc.) may need to be redesigned to add new cache lines as additional index values mapped to physical addresses in the additional cache memory.

Such conventional solutions are typically expensive to implement and may require re-designing an entire SoC to increase the available cache memory or other functional capability of the SoC. Performance also suffers when additional cache elements are arranged on the same planar die as the processor core and other cache memories. For example, manufacturing variabilities between semiconductor die characteristics of a cache extension and other cache memories closer to a processor core (and/or on the same base die as the processor core) could result in inconsistent latency, bandwidth, failure rate, etc., from adjacent cache lines mapped to different physical memories. As another example, a long separation distance between the processor core and the supporting cache elements causes high communication latency and increases complexity of power and signal routing between them. Additionally, conventional approaches typically involve modifying a cache controller to simply map additional cache memory space as additional index lines that are treated equally when mapping system memory locations to individual cache lines in the combined cache, i.e. without accounting for the variability of die characteristics, such as latency and bandwidth characteristics, of each individual semiconductor die that physically stores respective portions of the combined cache memory.

The techniques described herein enable improving the cache capacity, scalability, and utility of existing cache-based dies efficiently and without necessarily re-designing existing SoC semiconductor dies to support different cache memory capacities. To achieve this, an example system includes a base die configured to couple with one or more optional stacked dies in a stack arrangement. To increase cache capacity, for example, an additional stacked die is mounted and minor adjustments are implemented in a cache controller's algorithms (e.g., placement/replacement policies, etc.) to efficiently map the additional memory space to new cache lines while accounting for manufacturing variabilities and other characteristics of the individual semiconductor dies on which physical memories of the cache are integrated. Additionally, the techniques described herein harness knowledge about variabilities between individual semiconductor dies to improve the overall performance of the cache system. For example, when assigning a cache line to cache a certain data element, die-specific characteristics such as latency can be used to decide which semiconductor die is most suitable for caching that specific data element (e.g., frequently accessed data can be stored in lower latency dies, etc.).

In one example, a system includes a first physical memory integrated within a base die and a second physical memory integrated within a stacked die. The base die and the stacked die are coupled in a stack arrangement (e.g., 3D stacked die configuration, etc.). The system also includes a cache controller configured to implement a set associative cache that includes a plurality of cache ways.

Generally, a set associative cache is a type of cache that is implemented by dividing available cache memory into a number of equally sized memory blocks, also referred to as ways. In this way, a set associative cache maps a memory address of a system memory to a way instead of a cache line. For instance, when attempting to read cached data corresponding to a memory address, the memory address is translated to an index value that is checked in each of the cache ways for a hit. Set associative caches advantageously reduce the likelihood of cache thrashing and other issues associated with direct mapped caching systems, thereby improving program execution speed while providing improved deterministic execution.

Continuing with the example system, the cache controller is configured to map the plurality of cache ways such that all cache lines of each cache way are mapped to physical memory of one semiconductor die. For example, where the plurality of cache ways include two cache ways (two-way set associative cache), a first cache way is defined to include memory space within the first physical memory of the base die only and a second cache way is defined to include memory space within the second physical memory of the stacked die only. Furthermore, if an additional stacked die is added to the system, the cache controller is configured to update the plurality of cache ways to include a third cache way within a third physical memory of the additional stacked die (e.g., a 3-way set associative cache). In other words, all the index values of any particular cache way correspond to physical memory space within one particular semiconductor die only. In this way, the example system can be scaled in a cost-efficient manner by conveniently incorporating as many optional stacked dies as necessary to achieve a desired cache capacity, even if the semiconductor die node technology (e.g., 3 nm, 5 nm, etc.) of each individual die is different.

In some implementations, the example system is configured to select one of the plurality of cache ways for caching data (e.g., obtained from the system memory) or evicting previously cached data based at least in part on die characteristics of the base die and the stacked die. Conventional placement/replacement policies, for instance, may select any available cache way to store a newly obtained data element. In accordance with the present techniques however, the placement/replacement policy takes into account the different die characteristics of the base die (including the first cache way) and the stacked die (including the second cache way). As an example, data that is accessed frequently could be prioritized for caching in the first cache way if the base die is deemed to have a lower latency (e.g., due to being closer to processor core) than the stacked die. As another example, if a quality of service (QOS) of the system indicates that a first processor core is to be prioritized over a second processor core, then data that is cached for the first processor core can be assigned to a cache way associated with lower latency (e.g., first cache way) and data that is cached for the second processor core can be assigned to a cache way associated with higher latency (e.g., second cache way).

More generally, mapping each cache way to a single respective semiconductor die in accordance with the present disclosure advantageously enables the example system to optimize memory management processes, such as replacement policy algorithms, data routing policies, etc., to selectively control which cache way to use, assign, or evict for a certain piece of data while also benefiting from the different die characteristics of each semiconductor die. Furthermore, the described techniques mitigate, reduce, and/or eliminate data inconsistency and other performance issues associated with conventional systems that map a cache way to physical memories on different semiconductor dies due to the different latency and/or bandwidth characteristics of each die.

In some aspects, the techniques described herein relate to a system including: a first physical memory integrated within a first die; a second physical memory integrated within a second die, wherein the first die and second die are coupled in a stack arrangement; and a cache controller configured to implement a plurality of cache ways of a set associative cache, the plurality of cache ways including a first cache way defined within the first physical memory and a second cache way defined within the second physical memory.

In some aspects, the techniques described herein relate to a system, wherein the cache controller is further configured to select one of the plurality of cache ways to cache data in the set associative cache or to evict the cached data from the set associative cache.

In some aspects, the techniques described herein relate to a system, wherein the cache controller is configured to select the one of the plurality of cache ways based at least in part on die characteristics of the first die and the second die.

In some aspects, the techniques described herein relate to a system, wherein the die characteristics include at least one of latency, data communication bandwidth, or memory space availability.

In some aspects, the techniques described herein relate to a system, wherein the cache controller is configured to select the one of the plurality of cache ways based at least in part on data characteristics of the cached data.

In some aspects, the techniques described herein relate to a system, wherein the data characteristics include at least one of data access frequency or quality of service metrics associated with the cached data.

In some aspects, the techniques described herein relate to a system, wherein the cache controller is configured to select the one of the plurality of cache ways based at least in part on a state of a system component associated with the data.

In some aspects, the techniques described herein relate to a system, wherein the state of the system component includes at least one of the system component requesting the data as part of a pre-fetch command, or the system component requesting the data for execution.

In some aspects, the techniques described herein relate to a system, wherein the cache controller is further configured to select the one of the plurality of cache ways based at least in part on a power consumption of the system or a system component.

In some aspects, the techniques described herein relate to a system, wherein the cache controller is further configured to, in response to the power consumption exceeding a threshold level: transfer cached data out of the second physical memory; update the set associative cache to remove the second cache way from the plurality of cache ways; and reduce an amount of power provided to the second die.

In some aspects, the techniques described herein relate to a device including: a first physical memory integrated within a first die; and a cache controller, the cache controller configured to: map a plurality of cache ways of a set associative cache, the plurality of cache ways including a first cache way defined within the first physical memory; detect that a second die is coupled to the first die in a stack arrangement, the second die including a second physical memory integrated within the second die; and update the plurality of cache ways to include a second cache way defined within the second physical memory.

In some aspects, the techniques described herein relate to a device, wherein the cache controller is configured to update the plurality of cache ways in response to the detection of the second die.

In some aspects, the techniques described herein relate to a device, wherein the cache controller is further configured to select one of the plurality of cache ways to cache data in the set associative cache or to evict the data from the set associative cache.

In some aspects, the techniques described herein relate to a device, wherein the cache controller is configured to select the one of the plurality of cache ways based at least in part on die characteristics of the first die and the second die.

In some aspects, the techniques described herein relate to a device, wherein the cache controller is configured to select the one of the plurality of cache ways based at least in part on data characteristics of the data.

In some aspects, the techniques described herein relate to a device, wherein the cache controller is configured to select the one of the plurality of cache ways based at least in part on a state of a system component associated with the data.

In some aspects, the techniques described herein relate to a method including: mapping a plurality of cache ways of a set associative cache, the plurality of cache ways including a first cache way defined to be within a first physical memory, the first physical memory being integrated within a first die; detecting that a second die is coupled to the first die in a stack arrangement and that a second physical memory is integrated within the second die; and updating the plurality of cache ways to include a second cache way defined to be within the second physical memory.

In some aspects, the techniques described herein relate to a method, wherein updating the plurality of cache ways is in response to the detection of the second die.

In some aspects, the techniques described herein relate to a method, further including selecting one of the plurality of cache ways to cache data in the set associative cache or to evict the cached data from the set associative cache.

In some aspects, the techniques described herein relate to a method, wherein selecting the one of the plurality of cache ways is based at least in part on die characteristics of the first die and the second die.

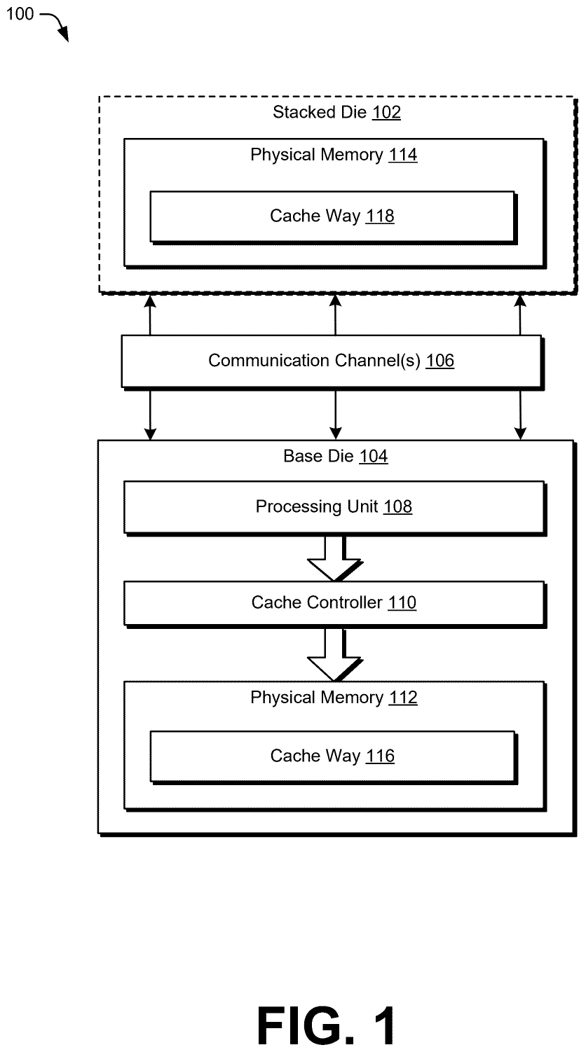

FIG. 1 is a block diagram of a non-limiting example system 100 having one or more dies operable to implement communication channels for a stacked die configuration. In this example, the system 100 includes a stacked die 102 and a base die 104. The base die 104 includes a processing unit 108, a cache controller 110, and physical memory 112 (e.g., volatile or nonvolatile memory) that are communicatively coupled to one another. The stacked die 102 includes another physical memory 114 (e.g., volatile or nonvolatile memory). The stacked die 102 and/or the base die 104 are configurable to be implemented by a device in a variety of ways. Examples of which include, by way of example and not limitation, computing devices, servers, mobile devices (e.g., wearables, mobile phones, tablets, laptops), processors (e.g., graphics processing units, central processing units, and accelerators), digital signal processors, disk array controllers, hard disk drive host adapters, memory cards, solid-state drives, wireless communications hardware connections, Ethernet hardware connections, switches, bridges, network interface controllers, and other apparatus configurations.

It is to be appreciated that in various implementations, the stacked die 102 and/or base die 104 is configured as any one or more of those devices listed just above and/or a variety of other devices without departing from the spirit or scope of the described techniques. In one example, the stacked die 102 includes fewer or more components (e.g., a processing unit, a cache controller, etc.) than those shown. In another example, the system 100 alternatively includes more than one stacked die.

In some examples, the stacked die 102 and/or the base die 104 are examples of dies. During a manufacturing process of a processor and/or memory, a semiconductor material is split into individual semiconductor components, referred to as dies. In variations, a die is configured to implement aspects of a memory and/or a processor. By way of example, a die includes circuitry configured to store and access data and/or execute instructions. The circuitry includes one or more transistors arranged to implement functionality of a processor and/or memory. The circuitry is arranged and also applied using logic that enables the stacked die 102 and/or the base die 104 to carry out the functionalities described above and below.

A processor component, such as the stacked die 102 and/or the base die 104, includes one or more execution units, control units, registers, cache memories, and other functional units that enable execution of instructions. Execution units are functional components within a processor that perform types of operations, including arithmetic operations, logic operations, and/or operations related to data movement. Example execution units include, but are not limited to, an arithmetic logic unit (ALU) for performing basic arithmetic, a floating-point unit (FPU) for performing floating-point arithmetic operations, a load-store unit for loading data from memory into registers and storing data from registers back to memory, and a memory management unit to translate virtual addresses to physical addresses for memory access and management, among others. A control unit (e.g., the cache controller 110 and/or other controller) manages the execution of instructions, directs flow of data, and coordinates operations within the stacked die 102 and/or the base die 104. For example, a control unit manages execution of instructions retrieved from memory, including decoding the instructions and controlling the flow of data in response to the instructions between different components of the stacked die 102 and/or the base die 104.

The stacked die 102 and/or the base die 104 are manufactured from a substrate (e.g., made from silicon) and include electronic circuits that performs various operations on and/or using data in the physical memory 112 and/or 114. Examples of the stacked die 102 and/or the base die 104 include, but are not limited to, a central processing unit (CPU), a graphics processing unit (GPU), a field programmable gate array (FPGA), an accelerator, an accelerated processing unit (APU), and a digital signal processor (DSP), to name a few. The processing unit 108, also referred to as a core, reads and executes instructions (e.g., of a program), examples of which include to add, to move data, and to branch. Although one processing unit 108 is depicted in the illustrated example, in variations, the stacked die 102 and/or the base die 104 include more than one processing unit 108 (e.g., a multi-core processor).

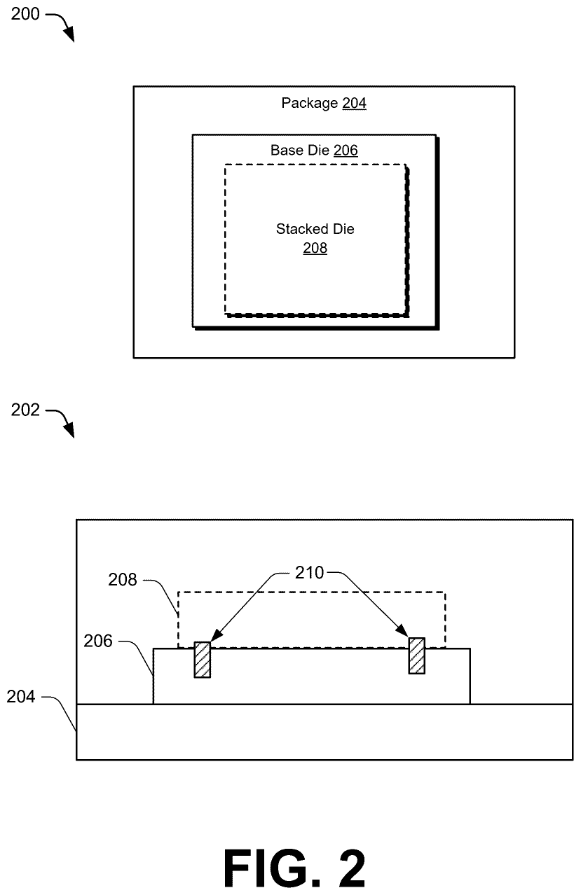

In some examples, the stacked die 102 and the base die 104 are manufactured in a 3D architecture, such that one or more processor components (e.g., the stacked die 102) are bonded to a base die 104. In variations, the stacked die 102 and the base die 104 are manufactured independently and subsequently assembled via bonding techniques as layers in a stack of processor and/or memory components, which is described in further detail with respect to FIG. 2. Vertical interconnects, referred to as through-silicon vias (TSVs), are introduced in the stacked die 102 and/or the base die 104 to provide communication between the different layers or dies in the stack. It is to be appreciated that the stacked die 102 has any numerical quantity of stacked dies and/or processor/memory components.

In other examples, the base die 104 is manufactured in a 2D architecture, such that the base die 104 does not have a stacked die 102. That is, the base die 104 is optionally coupled with the stacked die 102.

The dies representing different layers of a stack for a 3D architecture and/or a die in a 2D architecture are configured to implement functionality of a processor and/or a memory by utilizing communication channels 106. The communication channels 106 are components of the system 100 that facility movement of data between components of a die for the 2D architecture or components of multiple dies in a stack for the 3D architecture. For example, the communication channels 106 provide for routing data between the processing unit 108, the cache controller 110, and/or the physical memory 112, 114, among other components of the stacked die 102 and the base die 104. Example communication channels 106 include, but are not limited to, TSVs when moving data between layers and/or memory channels, buses (e.g., a data bus), interconnects, traces, or planes within a die to move data to different locations or components of the die.

Although the stacked die 102 is depicted and described as implementing aspects of a memory, in variations, the stacked die 102 implements aspects of processor and/or a cache controller in addition to, or as an alternative to, a memory.

In the illustrated example, the processing unit 108 executes software (e.g., an operating system, applications, etc.) to issue a memory request to the cache controller 110. The memory request is configurable to cause storage (e.g., programming) of data to physical memory as a write request or read data from the physical memory 112 and/or 114 as a read request. The cache controller 110 is configured to manage use of memory cells in the physical memory 112 and 114. Memory cells are configured in hardware of the physical memory 112 and 114 as electronic circuits that are used to store data. It is to be appreciated also, that in at least one variation, the system 100 does not include one or more of the depicted components and/or includes different components without departing from the spirit or scope of the described techniques.

In at least one example, the physical memory 112 and 114 are hardware components that store data (e.g., at least temporarily) so that a future request for the data is served faster from the physical memory 112 and/or 114 than from a data store maintained outside the system 100 (e.g., in another memory that is not shown). Examples of a data store include main memory (e.g., random access memory), a higher-level cache (not shown), secondary storage (e.g., a mass storage device), and removable media (e.g., flash drives, memory cards, compact discs, and digital video disc). In one or more implementations, the physical memory 112 and/or 114 are each at least one of smaller than the data store, faster at serving data to a requestor than the data store, or more efficient at serving data to the requestor than the data store. Additionally, or alternatively, the physical memory 112 and/or 114 are located closer to a requestor (e.g., the processing unit 108) than an external data store. It is to be appreciated that in various implementations the physical memory 112 and/or 114 have additional or different characteristics which make serving at least some data to a requestor from the physical memory 112 and/or 114 advantageous over serving such data from a data store.

In one or more implementations, the cache controller 110 uses the physical memory 112 and/or 114 to implement a memory cache, such as a particular level of cache (e.g., L1 cache) that is included in a hierarchy of multiple cache levels (e.g., L0, L1, L2, L3, and L4). In some examples, the cache controller 110 implements the cache at least partially in software or in different ways without departing from the spirit or scope of the described techniques.

In one or more implementations, the physical memory 112 and/or 114 includes one or more registers and/or one or more cache memories. The cache controller 110 utilizes registers to store and access data that is actively being processed or manipulated. Additionally, or alternatively, the stacked die 102 and/or the base die 104 utilize the physical memory 112 and/or 114 as one or more cache memories (e.g., multiple level cache memory) to store and access frequently utilized data.

In at least one implementation, the cache controller 110 is configured to implement a set associative cache that includes a plurality of cache ways using the physical memory 112 and 114. A set associative cache is organized such that the available physical memory space in physical memory 112 and 114 is divided into equally sized pieces or blocks, also referred to as cache ways. In a set associative cache implementation, each memory location in a data store (not shown), such as a main memory (DRAM), is mapped to a cache way instead of being mapped to a particular cache line. For example, an index field of a main memory address is mapped to an individual cache line in each cache way. To select one of the cache ways for the memory address, the tags of each individual cache line of each cache way is checked to determine if it is a hit, for instance. Set associative cache systems advantageously enhance program execution speed and mitigate the likelihood of cache thrashing.

In accordance with the present disclosure, the cache controller 110 is configured to implement the set associative cache such that each cache way of the plurality of cache ways is defined to point to physical addresses in a single one of the physical memory 112 (of the base die 104) or the physical memory 114 (of the stacked die 102). In this way, all the cache lines of a particular cache way are stored on a single semiconductor die thereby enabling the cache way to behave in a consistent manner due to the uniform die characteristics of all the cache lines in the cache way. In the illustrated example for instance, the cache controller 110 defines a first cache way 116 within the physical memory 112 of the base die 104 and a second cache way 118 within the physical memory 114 of the stacked die 102. Although a single cache way is depicted in each of physical memory 112 and 114, in alternative or additional examples, the physical memory 112 and/or 114 includes more than one cache way.

In at least some implementations, the cache controller 110 is configured to update the plurality of cache ways 116, 118 in response to detecting the presence of an additional stacked die (not shown) being coupled to the base die 104 or the stacked die 102 in a stack arrangement. For example, if the cache controller 110 detects an additional stacked die (not shown) is disposed on the base die 104 or the stacked die 102, the cache controller 110 responsively adds one or more additional cache ways within a physical memory (not shown) of the additional cache way and adjusts its data routing, placement, and/or replacement policies accordingly when assigning, selecting, or evicting cached data from the plurality of cache ways. Similarly, in some examples, the cache controller 110 is configured to detect removal of the stacked die 102 and responsively adjust the plurality of cache ways to remove cache way 118 from the plurality of cache ways.

In some examples, the cache controller 110 is configured to select one of the plurality of cache ways 116, 118 (e.g., to cache data corresponding to a memory location in a system memory, to evict previously cached data, etc.) based at least in part on die characteristics of the base die 104 and/or the stacked die 102 (e.g., latency, data communication bandwidth, memory space availability, etc.), data characteristics of the data that is to be cached or evicted (e.g., data access frequency, QoS metrics, etc.), a state of a system component associated with the data (e.g., data cached in response to a pre-fetch command from a memory management unit routed to higher latency die, data needed to advance execution by a processor core routed to lower latency die, etc.), and/or a power consumption of the system 100 or a component of the system 100.

In an example, when the system 100 is operating in a power-constrained environment (e.g., current power consumption of the system or a system controller is above a threshold level, remaining power budget of the system at a low level, etc.), the cache controller 110 evicts or transfers cached data out of the stacked die 102 (e.g., by flushing the cache lines in cache way 118 back to main memory or to a higher level cache, or by transferring the cached data to the cache way 116), updates the set associative cache configuration to remove cache way 118, and then reduces power provided to the stacked die 102 (e.g., by using gated clocks or by reducing a power budget of the stacked die 102 and/or one or more components therein. Additionally, in some examples, if the system 100 detects that it is no longer operating in the power-constrained environment (e.g., current power consumption of the system or a system component is below the threshold level, etc.), then the cache controller 110 restores power provided to the stacked die 102 and remaps the cache way 118 and/or one or more other cache ways in the physical memory 114 as part of the plurality of cache ways of the set associative cache defined by the cache controller 110.

In some examples, the controller 110 is configured to adjust memory management processes such as replacement policy algorithms, data routing policies, etc., to selectively control which of the cache lines in the base die 104 or the stacked die 102 to use, evict, or assign for caching a certain piece of data based on a variety of factors, such as: characteristics of the respective dies (e.g., base die associated with lower latency than stacked die, etc.), characteristics of a cache line (e.g., hotness of data, cache line access frequency from a lower level cache), quality of service metrics (e.g., data from core A is to get priority over data from core B on the base die, etc.), state of system component associated with cached data (e.g., data needed by a core prioritized for base die caching over data retrieved for a pre-fetch command). As another example, variations in the characteristics of the base die and the stacked die with respect to latency, bandwidth, recent traffic, remaining free space, etc., can be considered by the replacement policy to optimize the overall performance of the system.

FIG. 2 depicts a non-limiting example top view 200 and side view 202 of a stacked die configuration. The non-limiting example top view 200 and side view 202 include, or are implemented by, aspects of the system 100. For example, the non-limiting example top view 200 and side view 202 include a package 204 with a base die 206, a stacked die 208, and one or more communication channels 210, where the base die 206 is an example of a base die 104, the stacked die 208 is an example of a stacked die 102, and the communication channels 210 are examples of communication channels 106.

The stacked die 208 is depicted above a portion of the base die 206, however, in some examples the stacked die 208 is below the base die 206. For simplicity of the drawings, the base die 206 is depicted directly next to the stacked die 208. In one or more implementations, additional layers are arranged between the base die 206 and the stacked die 208 (e.g., dielectric layers for electrically isolating individual layers).

In some examples, one or more dies that make up an integrated circuit or chip are housed by a package 204. The package 204 provides mechanical support, electrical insulation, heat dissipation, and connection points for external circuitry, among other benefits, for the dies. In variations, the package 204 is manufactured from ceramic material, plastic material, and/or metal alloys. Although the package 204 is illustrated as surrounding the base die 206 and the stacked die 208, the package 204 is any shape or size.

As described with reference to FIG. 1, one or more dies that make up a chip are optionally stacked during a manufacturing process. For example, a base die 206 is configured to be coupled with one or more stacked dies 208. In variations, although the base die 206 is configured to be coupled with the stacked dies 208, the base die 206 is not coupled with the stacked dies 208. That is, the base die 206 makes up the chip (e.g., without additional dies). An example 3D die, or stacked die, configuration includes, but is not limited to, one or more dies stacked vertically on top of a base die 206. Coupling the stacked dies 208 to the base die 206 and/or to another stacked die 208 includes bonding the stacked dies 208 to the base die 206 and/or to the other stacked die 208.

In some examples, a base die 206 and/or a stacked die 208 can detect the presence or absence of another die. For example, the base die 206 detects the presence of one or more stacked die 208, while the stacked die 208 detects the presence of the base die 206 and/or one or more additional stacked dies 208. In one or more implementations, the base die 206 and/or the stacked dies 208 include solder joints that contact a pad on an adjacent die to create an electrical connection. The base die 206 and/or the stacked die 208 utilizes information regarding whether the electrical connection is established or not to detect the presence of the stacked die 208 (e.g., to detect whether the dies are in a 3D die configuration). Similarly, the base die 206 and/or the stacked die 208 utilize fuse information, configuration information, or any other information that indicates the presence or absence of a stacked die 208 coupled with the base die 206 and/or another stacked die 208 coupled with the stacked die 208.

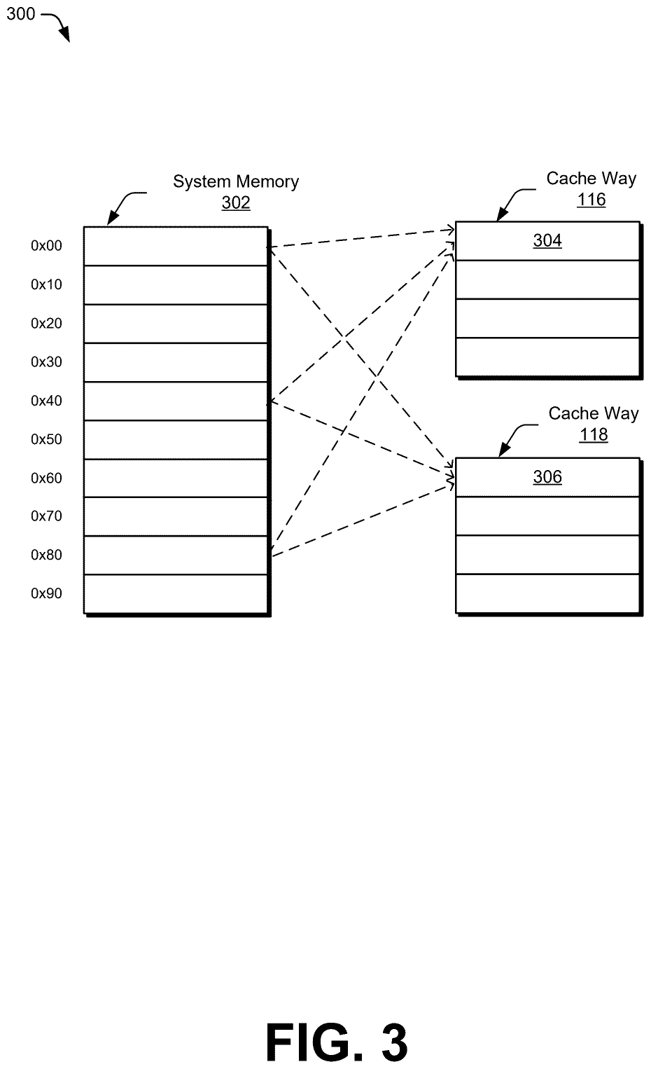

FIG. 3 depicts a non-limiting example system 300 operable to implement a set associative cache. The system 300 illustrates a non-limiting example mapping between a system memory 302 (e.g., main memory, DRAM, data store, etc.) and the plurality of cache ways 116, 118. In the illustrated example, the system memory 302 includes ten memory addresses (labeled as 0x00 to 0x90) corresponding the stored data lines that can be cached in either cache way 116 or 118 as cache lines. For example, cache ways 116 and 118 implement a 2-way set associative cache where data from address 0x00 (or 0x40 or 0x80) of the system memory 302 could be cached either at cache line 304 (i.e., line 0 out of 4) of cache way 116 (i.e., on the base die 104) or at cache line 306 (i.e., line 0 out of 4) of cache way 118 (i.e., on the stacked die 102).

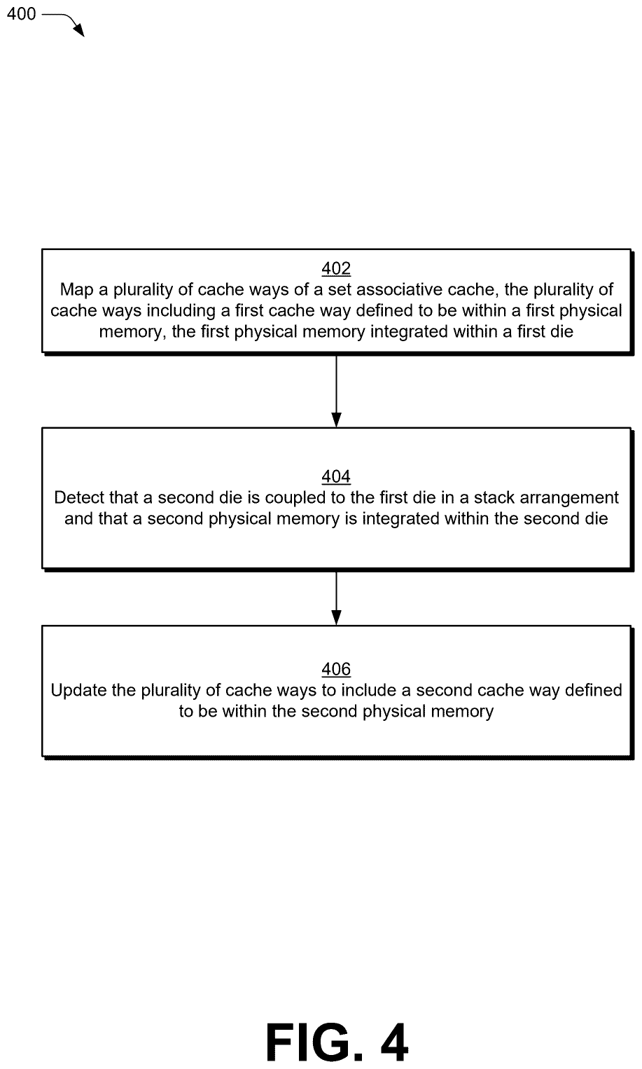

FIG. 4 depicts a procedure in an example 400 implementation of cache data distribution for a stacked die configuration.

At block 402, the cache controller 110 (or other controller of the system 100) maps a plurality of cache ways 116, 118, etc. of a set associative cache. For example, data stored at addresses 0x00, 0x40, 0x80 of system memory 302 is mapped to the first line of each of cache ways 116 and 118. Further, in examples, the plurality of cache ways include a first cache way 116 defined to be within a first physical memory 112 integrated within a first die (e.g., base die 104).

At block 404, the cache controller 110 (or other controller) detects that a second die (e.g., stacked die 102) is coupled to the first die (e.g., base die 104) in a stack arrangement and that a second physical memory 114 is integrated within the second die 102.

At block 406, the cache controller 110 (or other controller) updates the plurality of cache ways to include the second cache way 118 defined to be within the second physical memory 114 (e.g., in response to detecting the second die 102). Thus, in some examples, the cache controller 110 is configured to automatically or optionally update the plurality of cache ways to include additional cache ways (e.g., when a new stacked die is detected) or to remove previously defined cache ways (e.g., if a previously installed stacked die is removed); and to then update its placement/replacement policies for the set associative cache accordingly.

It should be understood that many variations are possible based on the disclosure herein. Although features and elements are described above in particular combinations, each feature or element is usable alone without the other features and elements or in various combinations with or without other features and elements.

The various functional units illustrated in the figures and/or described herein (including, where appropriate, the stacked die 102, the base die 104, and the cache controller 110) are implemented in any of a variety of different manners such as hardware circuitry, software or firmware executing on a programmable processor, or any combination of two or more of hardware, software, and firmware. The methods provided are implemented in any of a variety of devices, such as a general purpose computer, a processor, or a processor core. Suitable processors include, by way of example, a general purpose processor, a special purpose processor, a conventional processor, a digital signal processor (DSP), a graphics processing unit (GPU), a parallel accelerated processor, a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

In one or more implementations, the methods and procedures provided herein are implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A system comprising:
a first physical memory integrated within a first die;
a second physical memory integrated within a second die, wherein the first die and second die are coupled in a stack arrangement; and
a cache controller configured to implement a plurality of cache ways of a set associative cache, the plurality of cache ways including a first cache way defined within the first physical memory and a second cache way defined within the second physical memory.

2. The system of claim 1, wherein the cache controller is further configured to select one of the plurality of cache ways to cache data in the set associative cache or to evict the cached data from the set associative cache.

3. The system of claim 2, wherein the cache controller is configured to select the one of the plurality of cache ways based at least in part on die characteristics of the first die and the second die.

4. The system of claim 3, wherein the die characteristics include at least one of latency, data communication bandwidth, or memory space availability.

5. The system of claim 2, wherein the cache controller is configured to select the one of the plurality of cache ways based at least in part on data characteristics of the cached data.

6. The system of claim 5, wherein the data characteristics include at least one of data access frequency or quality of service metrics associated with the cached data.

7. The system of claim 2, wherein the cache controller is configured to select the one of the plurality of cache ways based at least in part on a state of a system component associated with the data.

8. The system of claim 7, wherein the state of the system component includes at least one of the system component requesting the data as part of a pre-fetch command, or the system component requesting the data for execution.

9. The system of claim 2, wherein the cache controller is further configured to select the one of the plurality of cache ways based at least in part on a power consumption of the system or a system component.

10. The system of claim 9, wherein the cache controller is further configured to, in response to the power consumption exceeding a threshold level:
transfer cached data out of the second physical memory;
update the set associative cache to remove the second cache way from the plurality of cache ways; and
reduce an amount of power provided to the second die.

11. A device comprising:
a first physical memory integrated within a first die; and
a cache controller, the cache controller configured to:
map a plurality of cache ways of a set associative cache, the plurality of cache ways including a first cache way defined within the first physical memory;
detect that a second die is coupled to the first die in a stack arrangement, the second die including a second physical memory integrated within the second die; and
update the plurality of cache ways to include a second cache way defined within the second physical memory.

12. The device of claim 11, wherein the cache controller is configured to update the plurality of cache ways in response to the detection of the second die.

13. The device of claim 11, wherein the cache controller is further configured to select one of the plurality of cache ways to cache data in the set associative cache or to evict the data from the set associative cache.

14. The device of claim 13, wherein the cache controller is configured to select the one of the plurality of cache ways based at least in part on die characteristics of the first die and the second die.

15. The device of claim 13, wherein the cache controller is configured to select the one of the plurality of cache ways based at least in part on data characteristics of the data.

16. The device of claim 13, wherein the cache controller is configured to select the one of the plurality of cache ways based at least in part on a state of a system component associated with the data.

17. A method comprising:
mapping a plurality of cache ways of a set associative cache, the plurality of cache ways including a first cache way defined to be within a first physical memory, the first physical memory being integrated within a first die;
detecting that a second die is coupled to the first die in a stack arrangement and that a second physical memory is integrated within the second die; and
updating the plurality of cache ways to include a second cache way defined to be within the second physical memory.

18. The method of claim 17, wherein updating the plurality of cache ways is in response to the detection of the second die.

19. The method of claim 17, further comprising selecting one of the plurality of cache ways to cache data in the set associative cache or to evict the cached data from the set associative cache.

20. The method of claim 19, wherein selecting the one of the plurality of cache ways is based at least in part on die characteristics of the first die and the second die.
